(19) United States
(12) Patent Application Publication
(10) Pub. No.: US 2015/0029909 A1
(43) Pub. Date: Jan. 29, 2015

(54) BI-DIRECTIONAL SIGNAL BOOSTER

(71) Applicant: Wilson Electronics, LLC, St. George, UT (US)

(72) Inventors: Christopher K. Ashworth, St. George, UT (US); James Colin Clark, Washington, UT (US)

(21) Appl. No.: 13/951,188

(22) Filed: Jul. 25, 2013

(51) Int. Cl. H04B 7/145

(52) U.S. Cl. CPC H04B 7/145
USPC 370/279

(57) ABSTRACT

A signal booster may include first and second uplink gain units each configured to apply an uplink gain to an uplink signal. The signal booster may further include first and second downlink gain units each configured to apply a downlink gain to a downlink signal. The signal booster may also include a passive signal directing unit configured to communicatively couple the first uplink gain unit to the second uplink gain unit and to communicatively couple the first downlink gain unit to the second downlink gain unit.

### FIELD

The embodiments discussed herein are related to signal boosters.

### BACKGROUND

In a wireless communication system, communication may occur as uplink communications and downlink communications. Uplink communications may refer to communications that originate at a wireless communication device (referred to hereinafter as “wireless device”) and that are transmitted to an access point (e.g., base station, remote radio head, wireless router, etc.) associated with the wireless communication system. Downlink communications may refer to communications from the access point to the wireless device. Devices configured to receive and/or transmit wireless signals may be configured to separate the uplink signals from the downlink signals such that the devices may process the uplink and downlink signals separately.

Additionally, wireless communications may be used in a wide variety of applications and for a variety of uses. Because of the many uses, portions of a frequency spectrum (commonly referred to as “bands”) used for wireless communications may be designated for certain uses to help reduce interference experienced by the wireless communications. In some instances, the frequency ranges associated with designated bands may be separated by a certain degree of frequency spacing referred to as a “guard band.” The guard band may help reduce interference between signals transmitted within different designated bands. In some instances, the guard bands may be substantially narrow such that processing signals that may be transmitted in bands separated by a narrow guard band may be difficult.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of one or more embodiments, a signal booster may include first and second uplink gain units each configured to apply an uplink gain to an uplink signal. The signal booster may further include first and second downlink gain units each configured to apply a downlink gain to a downlink signal. The signal booster may also include a passive signal directing unit configured to communicatively couple the first uplink gain unit to the second uplink gain unit and to communicatively couple the first downlink gain unit to the second downlink gain unit.

In other embodiments, a signal booster may include a first amplifying ring that includes a first uplink gain unit communicatively coupled between first and second duplexers and a first downlink gain unit communicatively coupled between the first and second duplexers. The signal booster may also include a second amplifying ring that includes a second uplink gain unit communicatively coupled between third and fourth duplexers and a second downlink gain unit communicatively coupled between the third and fourth duplexers. The second and third duplexers may be communicatively coupled such that the communicatively coupled second and third duplexers are configured to communicatively couple the first uplink gain unit to the second uplink gain unit and to communicatively couple the first downlink gain unit to the second downlink gain unit.

In other embodiments, a method of amplifying a signal may include applying a first uplink gain to an uplink signal received at a first antenna and applying a first downlink gain to a downlink signal received at a second antenna. The method may also include, after applying the first uplink gain and the first downlink gain, directing the uplink signal and the downlink signal along a common path.

In other embodiments, a signal booster may include a first gain unit configured to apply a first gain to a first direction signal and a gain controller configured to adjust the first gain. The signal booster may also include a detector configured to detect a first signal level of a second direction signal before the gain controller adjusts the first gain and to detect a second signal level of the second direction signal after the gain controller adjusts the first gain. Additionally, the signal booster may include an oscillation detection unit configured to detect oscillations in the signal booster based on the first and second signal levels of the second direction signal.

In other embodiments, a method of detecting internal oscillations in a signal booster may include measuring a first signal level of a first direction signal in a signal booster and adjusting a gain applied to a second direction signal in the signal booster. The method may also include measuring a second signal level of the first direction signal after the gain applied to the second direction signal is adjusted and detecting oscillations in the signal booster based on the first signal level and the second signal level of the first direction signal.

In other embodiments, a method of detecting internal oscillations in a signal booster may include measuring a first signal level of a first direction signal in a first amplifying ring in a signal booster and adjusting a gain applied to a second direction signal in a second amplifying ring in the signal booster. The method may also include measuring a second signal level of the first direction signal in the first amplifying ring after the adjusting the gain applied to the second direction signal in the second amplifying ring and detecting oscillations in the second amplifying ring based on the first signal level and the second signal level.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example wireless communication system;

FIG. 2A is an embodiment of an example signal booster;

FIG. 2B is an embodiment of another example signal booster;

FIG. 3 is an embodiment of an example gain unit;

FIG. 4 is an embodiment of another example signal booster;

FIG. 5 is an embodiment of another example signal booster;

FIG. 6 is an embodiment of another example signal booster;

FIG. 7 is a flowchart of an example method of amplifying a signal;

FIG. 8 is a flowchart of an example method of detecting internal oscillations in a signal booster; and

FIG. 9 is a flowchart of another example method of detecting internal oscillations in a signal booster.

### DESCRIPTION OF EMBODIMENTS

According to some embodiments, a signal booster may include a first amplifying ring that includes a first uplink gain unit communicatively coupled between first and second duplexers and a first downlink gain unit communicatively coupled between the first and second duplexers. The signal booster may also include a second amplifying ring that includes a second uplink gain unit communicatively coupled between third and fourth duplexers and a second downlink gain unit communicatively coupled between the third and fourth duplexers.

The second and third duplexers may be communicatively coupled at their common ports such that the communicatively coupled second and third duplexers communicatively couple the first uplink gain unit to the second uplink gain unit and communicatively couple the first downlink gain unit to the second downlink gain unit. Configuring the second and third duplexers in the above-described manner may provide more isolation between an uplink signal path and a downlink signal path in the signal booster than in previous signal boosters with the same number of duplexers. By providing additional isolation, the signal booster may apply a higher gain to the uplink and/or downlink signal path with reduced risk of internal oscillation.

In some embodiments, a method of detecting internal oscillations in a signal booster is described. The method may include measuring a first signal level of a first direction signal in a signal booster and adjusting a gain applied to a second direction signal in the signal booster. The method may further include measuring a second signal level of the first direction signal after the gain applied to the second direction signal is adjusted and detecting oscillations in the signal booster based on the first signal level and the second signal level of the first direction signal. In some embodiments, the above method may be used in conjunction with the signal booster described above with the reduced number of duplexers to identify internal oscillations to the signal booster.

In the present disclosure, the terms “isolation” or “isolated” with respect to circuits (e.g., uplink paths, downlink paths, filters, etc.) may refer to reducing the presence of unwanted signals received by or within a circuit. For example, reducing the presence of uplink signals in a downlink path of a signal booster or reducing the presence of downlink signals in an uplink path of the signal booster may improve isolation between the uplink path and the downlink path. The isolation may be accomplished by directing unwanted signals away from particular circuits, attenuating the unwanted signals within the particular circuits, such as by filtering, or using any other suitable method or mechanism. In some embodiments, isolation may be referred to in decibels (dB) indicating a degree of attenuation of an unwanted signal in a particular circuit or path. For example, an isolation of 30 dB between uplink and downlink paths may indicate that a downlink signal may be attenuated by 30 dB in the uplink path and/or that an uplink signal may be attenuated by 30 dB in the downlink path.

The term “uplink” may refer to communications that are transmitted to the access point from the wireless device. The term “downlink” may refer to communications that are transmitted to the wireless device from the access point.

Additionally, the terms “frequency range,” “frequency band,” “communication band,” or “band” may refer to one or more applicable frequencies within the electromagnetic spectrum. In some embodiments, the terms “frequency range,” “frequency band,” “communication band,” or “band” may also refer to frequencies designated for a particular use (e.g., cellular communication, public safety communication, uplink communication, downlink communication, etc.).

Further, in some instances a “frequency range,” “band,” “frequency band,” or “communication band” may refer to a contiguous frequency range while in other instances the terms “frequency range,” “band,” “frequency band,” or “communication band” may refer to multiple non-contiguous frequency ranges. Additionally, as indicated above, a “frequency range,” “band,” “frequency band,” or “communication band” may include one or more sub-ranges or sub-bands (e.g., a frequency band may include an uplink band and a downlink band).

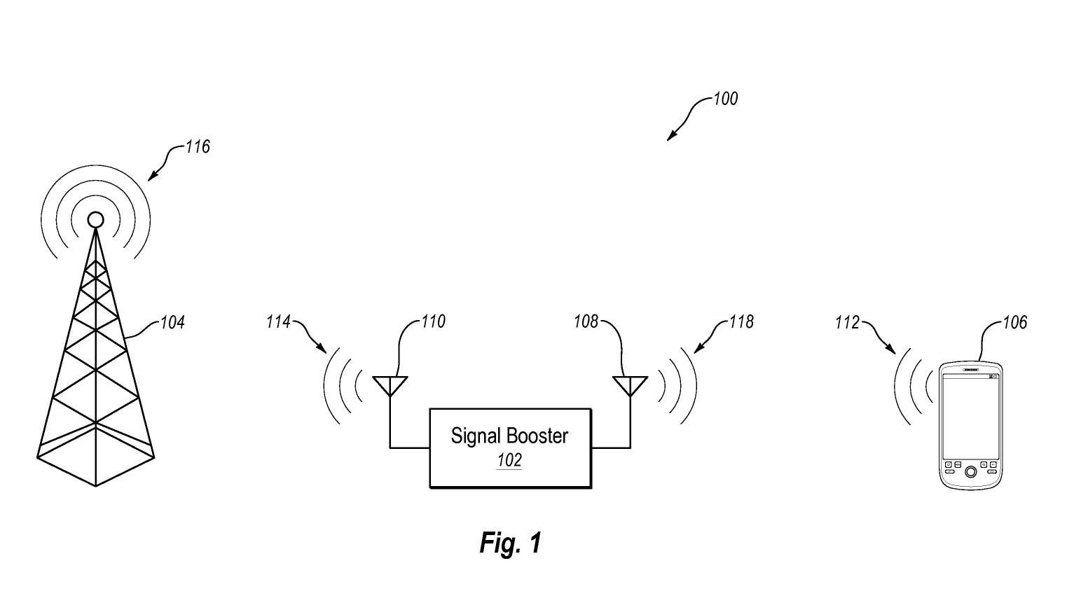

FIG. 1 illustrates an example wireless communication system 100 (referred to hereinafter as “system 100”), arranged in accordance with at least some embodiments described herein. The system 100 may be configured to provide wireless communication services to a wireless device 106 via an access point 104. The system 100 may further include a bi-directional signal booster 102 (referred to hereinafter as “the signal booster 102”). The signal booster 102 may be any suitable system, device, or apparatus configured to receive wireless signals (e.g., radio frequency (RF) signals) communicated between the access point 104 and the wireless device 106. The signal booster 102 may be configured to amplify, repeat, filter, and/or otherwise process the received wireless signals and may be configured to re-transmit the processed wireless signals. Although not expressly illustrated in FIG. 1, the system 100 may include any number of access points 104 configured to provide wireless communication services to any number of wireless devices 106.

The wireless communication services provided by the system 100 may include voice services, data services, messaging services, and/or any suitable combination thereof. The system 100 may include a Frequency Division Duplexing (FDD) network, a Frequency Division Multiple Access (FDMA) network, an Orthogonal FDMA (OFDMA) network, a Code Division Multiple Access (CDMA) network, a Time Division Multiple Access (TDMA) network, a Direct Sequence Spread Spectrum (DSSS) network, a Frequency Hopping Spread Spectrum (FHSS) network, and/or some other wireless communication network. In some embodiments, the system 100 may be configured to operate as a second generation (2G) wireless communication network, a third generation (3G) wireless communication network, a fourth generation (4G) wireless communication network, and/or a Wi-Fi network. In these or other embodiments, the system 100 may be configured to operate as a Long Term Evolution (LTE) wireless communication network.

The access point 104 may be any suitable wireless network communication point and may include, by way of example but not limitation, a base station, a remote radio head (RRH), a satellite, a wireless router, or any other suitable communication point. The wireless device 106 may be any device that may use the system 100 for obtaining wireless communication services and may include, by way of example and not limitation, a cellular phone, a smartphone, a personal data assistant (PDA), a laptop computer, a personal computer, a tablet computer, a wireless communication card, or any other similar device configured to communicate within the system 100.

As wireless signals propagate between the access point 104 and the wireless device 106, the wireless signals may be affected during the propagation such that, in some instances, the wireless signals may be substantially degraded. The signal degradation may result in the access point 104 or the wireless device 106 not receiving, detecting, or extracting information from the wireless signals. Therefore, the signal booster 102 may be configured to increase the power of and/or improve the signal quality of the wireless signals such that the communication of the wireless signals between the access point 104 and the wireless device 106 may be improved.

In some embodiments, the signal booster 102 may receive a wireless signal communicated between the access point 104 and the wireless device 106 and may convert the wireless signal into an electrical signal (e.g., via an antenna). The signal booster 102 may be configured to amplify the electrical signal and the amplified electrical signal may be converted into an amplified wireless signal (e.g., via an antenna) that may be transmitted. The signal booster 102 may amplify the electrical signal by applying a gain to the electrical signal. The gain may be a set gain or a variable gain, and may be less than, equal to, or greater than one. Therefore, in the present disclosure, the term “amplify” may refer to applying any gain to a wireless signal even if the gain is less than one.

In some embodiments, the signal booster 102 may adjust the gain based on conditions associated with communicating the wireless signals (e.g., providing noise floor, oscillation, and/or overload protection). In these and other embodiments, the signal booster 102 may adjust the gain in real time. The signal booster 102 may also filter out noise associated with the received wireless signal such that the retransmitted wireless signal may be a cleaner signal than the received wireless signal. Therefore, the signal booster 102 may improve the communication of wireless signals between the access point 104 and the wireless device 106.

For example, the wireless device 106 may communicate a wireless uplink signal 112 intended for reception by the access point 104 and a first antenna 108 may be configured to receive the wireless uplink signal. The first antenna 108 may be configured to convert the received wireless uplink signal 112 into an electrical uplink signal. Additionally, the first antenna 108 may be communicatively coupled to a first interface port (not expressly depicted in FIG. 1) of the signal booster 102 such that the signal booster 102 may receive the wireless uplink signal 112 at the first interface port. An interface port may be any suitable port configured to interface the signal booster 102 with another device (e.g., an antenna or a modem) from which the signal booster 102 may receive a signal and/or to which the signal booster 102 may communicate a signal.

In some embodiments, the signal booster 102 may be configured to apply a gain to the electrical uplink signal to amplify the electrical uplink signal. In the illustrated embodiment, the signal booster 102 may direct the amplified electrical uplink signal toward a second interface port (not expressly depicted in FIG. 1) of the signal booster 102 that may be communicatively coupled to a second antenna 110. The second antenna 110 may be configured to receive the amplified electrical uplink signal from the second interface port and may convert the amplified electrical uplink signal into an amplified wireless uplink signal 114 that may also be transmitted by the second antenna 110. The amplified wireless uplink signal 114 may then be received by the access point 104.

In some embodiments, the signal booster 102 may also be configured to filter the electrical uplink signal to remove at least some noise associated with the received wireless uplink signal 112. Consequently, the amplified wireless uplink signal 114 may have a better signal-to-noise ratio (SNR) than the wireless uplink signal 112 that may be received by the first antenna 108. Accordingly, the signal booster 102 may be configured to improve the communication of uplink signals between the access point 104 and the wireless device 106. The use of the term “uplink signal,” without specifying wireless or electrical uplink signals, may refer to wireless uplink signals or electrical uplink signals.

As another example, the access point 104 may communicate a wireless downlink signal 116 intended for the wireless device 106 and the second antenna 110 may be configured to receive the wireless downlink signal 116. The second antenna 110 may convert the received wireless downlink signal 116 into an electrical downlink signal such that the electrical downlink signal may be received at the second interface port of the signal booster 102. In some embodiments, the signal booster 102 may be configured to apply a gain to the electrical downlink signal to amplify the electrical downlink signal. The signal booster 102 may also be configured to direct the amplified electrical downlink signal toward the first interface port of the signal booster 102 such that the first antenna 108 may receive the amplified electrical downlink signal. The first antenna 108 may be configured to convert the amplified electrical downlink signal into an amplified wireless downlink signal that may also be transmitted by the first antenna 108. The amplified wireless downlink signal 118 may then be received by the wireless device 106.

In some embodiments, the signal booster 102 may also be configured to filter the electrical downlink signal to remove at least some noise associated with the received wireless downlink signal 116. Therefore, the amplified wireless downlink signal 118 may have a better SNR than the wireless downlink signal 116 received by the second antenna 110. Accordingly, the signal booster 102 may also be configured to improve the communication of downlink signals between the access point 104 and the wireless device 106. The use of the term “downlink signal,” without specifying wireless or electrical downlink signals, may refer to wireless downlink signals or electrical downlink signals.

Modifications may be made to the system 100 without departing from the scope of the present disclosure. For example, in some embodiments, the distance between the signal booster 102 and the wireless device 106 may be relatively close as compared to the distance between the signal booster 102 and the access point 104. Further, the system 100 may include any number of signal boosters 102, access points 104, and/or wireless devices 106. Additionally, in some embodiments, the signal booster 102 may be integrated with the wireless device 106, and in other embodiments, the signal booster 102 may be separate from the wireless device 106. Also, in some embodiments, the signal booster 102 may be included in a cradle configured to hold the wireless device 106. Additionally, in some embodiments, the signal booster 102 may be configured to communicate with the wireless device 106 via wired communications (e.g., using electrical signals communicated over a wire) instead of wireless communications (e.g., via wireless signals).

Additionally, although the signal booster 102 is illustrated and described with respect to performing operations with respect to wireless communications such as receiving and transmitting wireless signals via the first antenna 108 and the second antenna 110, the scope of the present disclosure is not limited to such applications. For example, in some embodiments, the signal booster 102 (or other signal boosters described herein) may be configured to perform similar operations with respect to communications that are not necessarily wireless, such as processing signals that may be received and/or transmitted via one or more modems communicatively coupled to the interface ports of the signal booster 102.

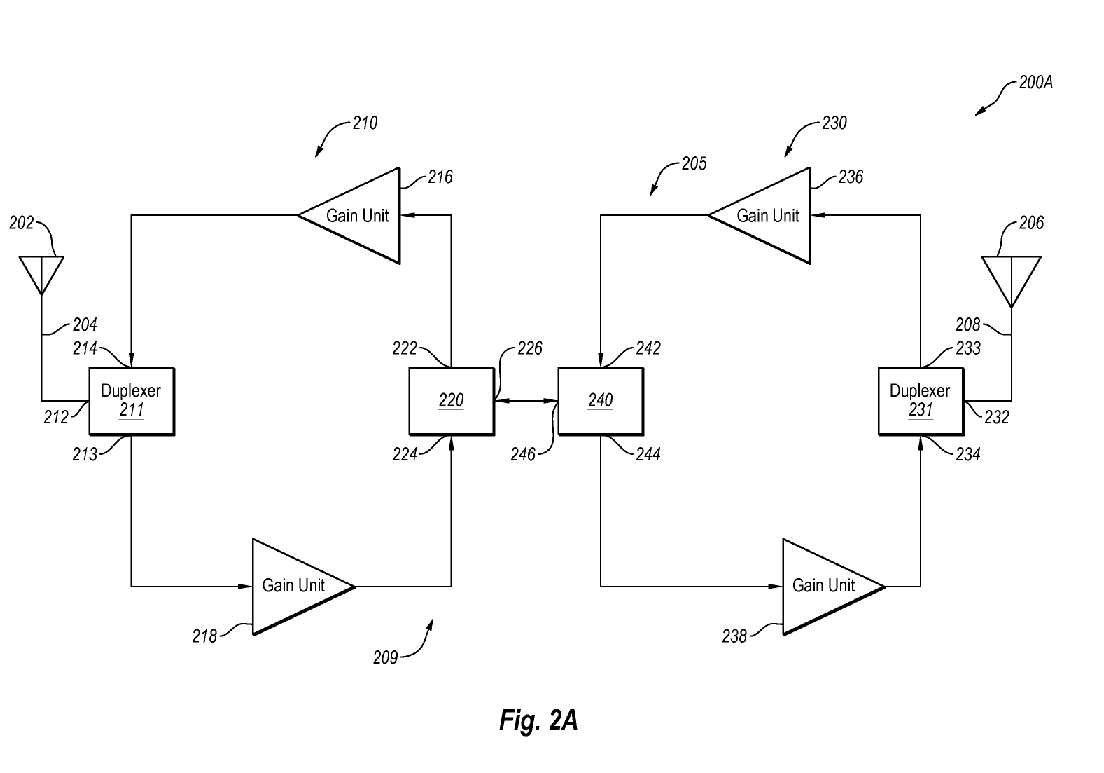

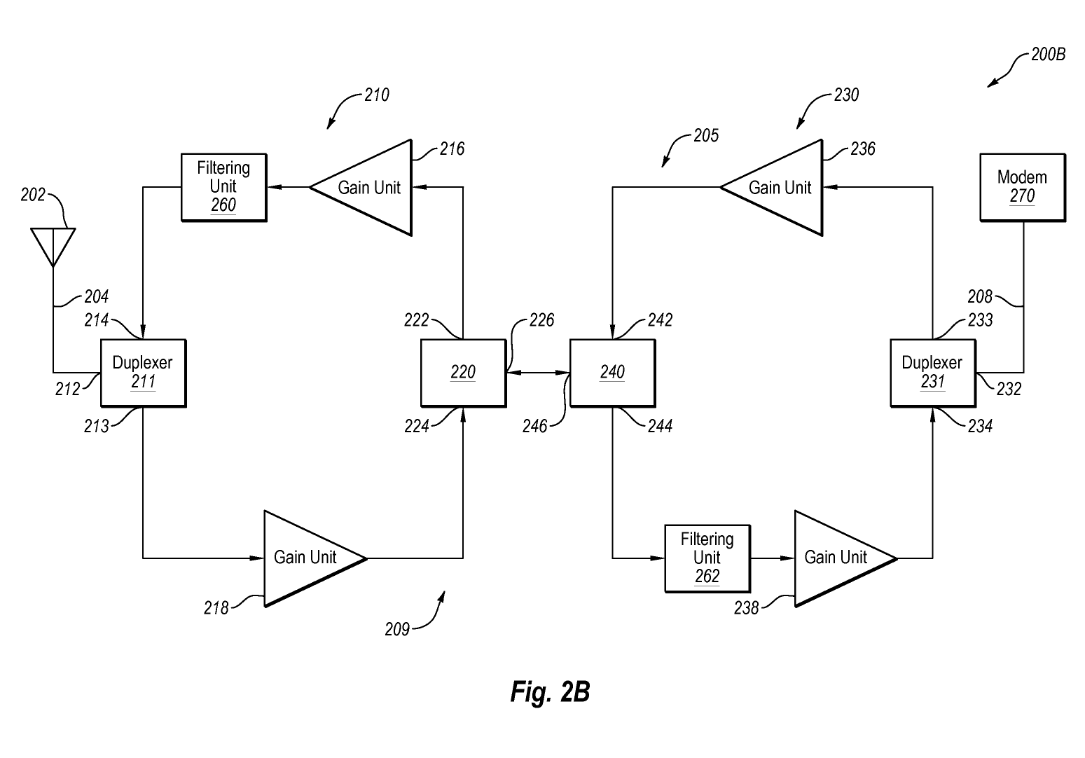

FIG. 2A illustrates an embodiment of an example signal booster 200A, arranged in accordance with at least some embodiments described herein. In some embodiments, the signal booster 200A may be implemented as the signal booster 102 of FIG. 1. In the illustrated embodiment, the signal booster 200A is configured to amplify signals communicated in an uplink band included in a communication band (e.g., the uplink band of the 3G Band 8) and a downlink band included in the communication band (e.g., the downlink band of the 3G Band 8).

The signal booster 200A may include a first interface port 204 communicatively coupled to a first antenna 202 and a second interface port 208 communicatively coupled to a second antenna 206. The signal booster 200A may also include an uplink path 205 and a downlink path 209, each communicatively coupled between the first interface port 204 and the second interface port 208. The signal booster 200A also includes first and second uplink gain units 216 and 236 and first and second downlink gain units 218 and 238, referred to herein collectively as gain units 216, 218, 236, and 238. The signal booster 200A also includes first and second common duplexers 211 and 231, respectively, and first and second passive signal directing units 220 and 240, respectively, referred to herein collectively as directing units 211, 220, 231, and 240. The first and second passive signal directing units 220 and 240 may be units configured to passively direct signals in one path at an intersection of multiple paths. Example passive signal directing units 220 and 240 include, but are not limited to, splitters, circulators, duplexers, triplexers, quadplexers, or some combination thereof, or some other component configured to perform operations described with respect to the first and second passive signal directing units 220 and 240.

The uplink path 205 may be configured to amplify uplink signals received at the second interface port 208 that may be transmitted by a wireless device (e.g., the wireless device 106 of FIG. 1), and communicate the amplified uplink signals to the first interface port 204 for transmission by the first antenna 202 such that an access point of a wireless communication system (e.g., the access point 104 of FIG. 1) may receive the amplified uplink signals. The uplink path 205 may include the first and second common duplexers 211 and 231, the first and second uplink gain units 216 and 236, and the first and second passive signal directing units 220 and 240.

The downlink path 209 may be similarly configured to amplify downlink signals received at the first interface port 204 that may be transmitted by the access point, and communicate the amplified downlink signals to the second interface port 208 for transmission by the second antenna 206 such that the wireless device may receive the amplified downlink signals. The downlink path 209 may include the first and second common duplexers 211 and 231, the first and second downlink gain units 218 and 238, and the first and second passive signal directing units 220 and 240.

The first common duplexer 211 may be configured to receive a downlink signal from the first interface port 204 at a common port 212 of the first common duplexer 211. The first common duplexer 211 may include a downlink filter associated with the downlink band mentioned above. The downlink filter may pass frequencies in the downlink band and may substantially attenuate frequencies not in the downlink band, e.g., frequencies in the uplink band. The downlink filter may communicatively couple the common port 212 with a downlink port 213 of the first common duplexer 211 and thus may pass the downlink signal received at the common port 212 to the downlink port 213 and into the downlink path 209 toward the first downlink gain unit 218.

The first common duplexer 211 may be further configured to receive an uplink signal propagating in the uplink path 205 at an uplink port 214. The first common duplexer 211 may include an uplink filter associated with the uplink band mentioned above. The uplink filter may pass frequencies in the uplink band and may substantially attenuate frequencies not in the uplink band, e.g., frequencies in the downlink band. The uplink filter may communicatively couple the uplink port 214 with the common port 212 of the first common duplexer 211 and thus may pass the uplink signal received at the uplink port 214 to the common port 212 and on to the first interface port 204.

The second common duplexer 231 may be configured to receive an uplink signal from the second interface port 208 at a common port 232 of the second common duplexer 231. The second common duplexer 231 may include an uplink filter associated with the uplink band mentioned above. The uplink filter may pass frequencies in the uplink band and may substantially attenuate frequencies not in the uplink band, e.g., frequencies in the downlink band. The uplink filter may communicatively couple the common port 232 with an uplink port 233 of the second common duplexer 231 and thus may pass the uplink signal received at the common port 232 to the uplink port 233 and on to the uplink path 205 toward the second uplink gain unit 236.

The second common duplexer 231 may be further configured to receive a downlink signal propagating in the downlink path 209 at a downlink port 234. The second common duplexer 231 may include a downlink filter associated with the downlink band mentioned above. The downlink filter may pass frequencies in the downlink band and substantially attenuate frequencies not in the downlink band, e.g., frequencies in the uplink band. The downlink filter may communicatively couple the downlink port 234 with the common port 232 of the second common duplexer 231 and thus may pass the downlink signal received at the downlink port 234 to the common port 232 and on to the second interface port 208.

The first passive signal directing unit 220 may be configured to receive a downlink signal propagating in the downlink path 209 from the first downlink gain unit 218 at a downlink port 224 of the first passive signal directing unit 220. In some embodiments, the first passive signal directing unit 220 may direct the downlink signal received at the downlink port 224 to the common port 226 and to a common port 246 of the second passive signal directing unit 240. In some embodiments, such as when the first passive signal directing unit 220 is a duplexer, the first passive signal directing unit 220 may include a downlink filter associated with the downlink band mentioned above. The downlink filter may communicatively couple a common port 226 of the first passive signal directing unit 220 with the downlink port 224 and thus pass the downlink signal received at the downlink port 224 to the common port 226 and to a common port 246 of the second passive signal directing unit 240.

The first passive signal directing unit 220 may be further configured to receive an uplink signal propagating in the uplink path 205 at the common port 226 from a common port 246 of the second passive signal directing unit 240. In some embodiments, the first passive signal directing unit 220 may direct the uplink signal received at the common port 226 to the uplink port 222 and to the first uplink gain unit 216. Note that in some embodiments, such as when the first passive signal directing unit 220 is a splitter, the first passive signal directing unit 220 may also direct the uplink signal received at the common port 226 to the downlink port 224 and to the first downlink gain unit 218. In these and other embodiments, the uplink signal directed to the first downlink gain unit 218 may be directed to the output of the first downlink gain unit 218 and does not pass through the first downlink gain unit 218.

In some embodiments, such as when the first passive signal directing unit 220 is a duplexer, the first passive signal directing unit 220 may include an uplink filter associated with the uplink band mentioned above. The uplink filter may communicatively couple the common port 226 with the uplink port 222 of the first passive signal directing unit 220 and thus may pass the uplink signal received at the common port 226 to the uplink port 222 and to the first uplink gain unit 216.

The second passive signal directing unit 240 may be configured to receive an uplink signal propagating in the uplink path 205 from the second uplink gain unit 236 at an uplink port 242 of the second passive signal directing unit 240. In some embodiments, the second passive signal directing unit 240 may direct the uplink signal received at the uplink port 242 to the common port 246 and to the common port 226 of the first passive signal directing unit 220. In some embodiments, such as when the second passive signal directing unit 240 is a duplexer, the second passive signal directing unit 240 may include an uplink filter associated with the uplink band mentioned above. The uplink filter may communicatively couple the uplink port 242 with a common port 246 of the second passive signal directing unit 240 and may pass an uplink signal received at the uplink port 242 to the common port 246. As indicated above, the common port 246 of the second passive signal directing unit 240 may be communicatively coupled to the common port 226 of the first passive signal directing unit such that the second passive signal directing unit 240 may pass the uplink signal to the common port 226 of the first passive signal directing unit 220.

The second passive signal directing unit 240 may be further configured to receive a downlink signal propagating in the downlink path 209 at the common port 246 from the common port 226 of the first passive signal directing unit 220. In some embodiments, the second passive signal directing unit 240 may direct the downlink signal received at the common port 246 to the downlink port 244 and to the second downlink gain unit 238. Note that in some embodiments, such as when the second passive signal directing unit 240 is a splitter, the second passive signal directing unit 240 may also direct the downlink signal received at the common port 246 to the uplink port 242 and to the second uplink gain unit 236. In these and other embodiments, the downlink signal directed to the second uplink gain unit 236 may be directed to the output of the second uplink gain unit 236 and does not pass through the second uplink gain unit 236.

In some embodiments, such as when the second passive signal directing unit 240 is a duplexer, the second passive signal directing unit 240 may include a downlink filter associated with the downlink band mentioned above. The downlink filter may communicatively couple the common port 246 with the downlink port 244 of the second passive signal directing unit 240 and thus pass the downlink signal received at the common port 246 to the downlink port 244 and to the second downlink gain unit 238.

The first and second uplink gain units 216 and 236 may each be configured to apply a gain to an uplink signal. The first and second downlink gain units 218 and 238 may each be configured to apply a gain to a downlink signal. The first and second uplink gain units 216 and 236 and the first and second downlink gain units 218 and 238 may each be configured similarly or differently. For example, in some embodiments, the first and second uplink gain units 216 and 236 and the first and second downlink gain units 218 and 238 may each include one or more amplifiers, one or more variable gain amplifiers, one or more attenuators, one or more variable attenuators, among other components, or any combination thereof. Furthermore, the first and second uplink gain units 216 and 236 and the first and second downlink gain units 218 and 238 may each apply similar or different gains to uplink and downlink signals, respectively.

Due to the configuration of the first and second passive signal directing units 220 and 240, the uplink path 205 and the downlink path 209 share a common path between the common ports 226 and 246 of the first and second passive signal directing units 220 and 240, respectively, that is between the first and second common duplexers 211 and 231. Even though the uplink path 205 and the downlink path 209 share a common path within the signal booster 200A, and more particularly, between the first and second common duplexers 211 and 231, each of the uplink and downlink paths 205 and 209 includes separate gain paths through the gain units 216, 218, 236, and 238.

An example of an uplink signal traversing the uplink path 205 and the common path between the first and second passive signal directing units 220 and 240 when the first and second passive signal directing units 220 and 240 are duplexers is as follows. The uplink signal may be received by the second antenna 206 and pass to the second interface port 208. The uplink signal may enter the common port 232 of the second common duplexer 231. The uplink filter in the second common duplexer 231 may pass the uplink signal out of the uplink port 233 to the second uplink gain unit 236. The second uplink gain unit 236 may apply a gain to the uplink signal and may pass the uplink signal to the uplink port 242 of the second passive signal directing unit 240. The second passive signal directing unit 240 may pass the uplink signal from the uplink port 242 to the common port 246 and out to the common port 226 of the first passive signal directing unit 220.

The uplink filter in the first passive signal directing unit 220 may receive the uplink signal from the common port 226 and may pass the uplink signal to the uplink port 222. The uplink port 222 may pass the uplink signal to the first uplink gain unit 216. The first uplink gain unit 216 may apply a gain to the uplink signal and send the uplink signal to the uplink port 214 of first common duplexer 211. The uplink filter of the first common duplexer 211 may receive the uplink signal from the uplink port 214 and may pass the uplink signal to the common port 212 and out to the first interface port 204. The first interface port 204 may pass the uplink signal to the first antenna 202. The first antenna 202 may transmit the uplink signal. A downlink signal may traverse a similar path along the downlink path 209.

In some embodiments, the signal booster 200A may be configured to provide a gain to an uplink signal and a downlink signal in uplink and downlink bands, respectively, that have a narrow guard band between them. In these and other embodiments, a mid-band frequency of the narrow guard band may be amplified by the gain units 216, 218, 236, and 238 because of slow roll of amplifiers within the gain units 216, 218, 236, and 238. For example, a downlink band may include frequencies between 1850 and 1910 megahertz (MHz) and an uplink band may include frequencies between 1930 and 1990 MHz such that the associated guard band may extend between 1910 and 1930 MHz. As a result, the mid-band frequency of the guard band may be 1920 MHz. In some embodiments, the amplifiers within the gain units 216, 218, 236, and 238 may have roll offs resulting in the gain units 216, 218, 236, and 238 amplifying the mid-band frequency of the guard band to amplify the frequencies in the respective uplink and downlink bands.

With both the first and second uplink gain units 216 and 236 and the first and second downlink gain units 218 and 238 amplifying a same frequency, an internal oscillation within the signal booster 200A may occur. An internal oscillation occurring at a frequency may raise the noise floor of the network in which the signal booster 200A is operating. A raised noise floor may be harmful to communication performed by other devices in the network, such as an access point or a wireless device. To reduce or eliminate internal oscillations of the signal booster 200A occurring at a mid-band frequency of a guard band that may be amplified by both the first and second uplink gain units 216 and 236 and the first and second downlink gain units 218 and 238, the signal booster 200A may provide more filtering/isolation at the mid-band frequency than amplification. The filtering/isolation in the signal booster 200A may be provided by the directing units 211, 220, 231, and 240. For example, assume that each of the directing units 211, 220, 231, and 240 provides 20 dB of filtering/isolation for a total of 80 dB of filtering/isolation. In this example, to prevent internal oscillations in the signal booster 200A, the combined amplification of the first and second uplink gain units 216 and 236 and the first and second downlink gain units 218 and 238 at any one frequency may be less than 80 dB.

In some embodiments, such as when the first and second passive signal directing units 220 and 240 are duplexers, the configuration of the signal booster 200A with the first and second passive signal directing units 220 and 240 provides greater filtering/isolation than in other known signal boosters with the same number of duplexers. In other known signal boosters that are used with uplink and downlink bands with narrow guard bands, a second duplexer is used in the uplink and downlink paths besides the duplexers for the common path to the antennas. These duplexers typically provide filtering between one port and the common port and the other port is tied to ground, thus using half of the filtering capabilities of the duplexer. Alternately or additionally, the other known signal boosters may use band-pass filters in the uplink and downlink paths besides the duplexers for the common path to the antennas. The configuration of the signal booster 200A with the first and second passive signal directing units 220 and 240 uses all of the filtering capabilities of the directing units 211, 220, 231, and 240 in the signal booster 200A, allowing the signal booster 200A to provide more amplification or apply a higher gain to uplink and downlink signals while not adding additional directing units, such as duplexers.

The configuration of the signal booster 200A with the first and second passive signal directing units 220 and 240 and the common signal path for both uplink and downlink signals results in the signal booster 200A having amplifying rings. For example, the signal booster 200A may include a first amplifying ring 210 and a second amplifying ring 230. The first amplifying ring 210 includes the first common duplexer 211, the first uplink gain unit 216, the first downlink gain unit 218, and the first passive signal directing unit 220. The second amplifying ring 230 includes the second common duplexer 231, the second uplink gain unit 236, the second downlink gain unit 238, and the second passive signal directing unit 240.

Each of the first and second amplifying rings 210 and 230 may have an internal oscillation as each includes a complete signal path. To reduce or prevent internal oscillations in the first and second amplifying rings 210 and 230, each of the first and second amplifying rings 210 and 230 may include filtering/isolation that is more than the amplification applied to a frequency by the gain units in the first and second amplifying rings 210 and 230. For example, to reduce or prevent internal oscillation in the first amplifying ring 210, the filtering/isolation provided by the first common duplexer 211 and the first passive signal directing unit 220 of a frequency may be more than a gain applied to the frequency by the first uplink gain unit 216 and the first downlink gain unit 218.

An example of the filtering/isolation of a signal by the first amplifying ring 210, when the first passive signal directing unit 220 is a duplexer, is as follows. A signal having a frequency at a mid-band of a guard band may have an amplitude approximately equal to the amplitude of a noise floor at a node between the downlink port 213 and the first downlink gain unit 218. The first downlink gain unit 218 may apply a gain to the signal of 18 dB. Due to the frequency of the signal, the first passive signal directing unit 220 may filter the signal by attenuating the signal by 20 dB. The signal at a node between the uplink port 222 and the first uplink gain unit 216 after filtering by the first passive signal directing unit 220 may thus have an amplitude approximately equal to the amplitude of the noise floor. The first uplink gain unit 216 may apply a gain to the signal of 18 dB. The first common duplexer 211 may filter the signal by attenuating the signal by 20 dB. In this example, the signal is constantly attenuated more than amplified, resulting in the signal not oscillating in the first amplifying ring 210 by continuing to gain in amplitude. For example, had the first common duplexer 211 and the first passive signal directing unit 220 attenuated the signal by 17 dB instead of 20 dB, the signal would have grown in amplitude and resulted in an internal oscillation in the first amplifying ring 210.

Modifications, additions, or omissions may be made to the signal booster 200A without departing from the scope of the present disclosure. For example, as mentioned above, in some embodiments, the signal booster 200A may include additional filters, such as additional band pass filters, half duplexers, among other components. Alternately or additionally, the signal booster 200A may include only one or none of the first and second antennas 202 and 206. Alternately or additionally, the signal booster 200A may include a component along the common path between the first and second passive signal directing units 220 and 240. For example, an attenuator, a gain unit, and/or a detection unit configured to detect signal levels may be communicatively coupled along the common path between the first and second passive signal directing units 220 and 240. Alternately or additionally, the first and/or second common duplexers 211 and 231 may be splitters, circulators, triplexers, or quadplexers, among other components.

FIG. 2B is an embodiment of another example signal booster 200B, arranged in accordance with at least some embodiments described herein. The signal booster 200B may be similar to the signal booster 200A of FIG. 2A, except the signal booster 200B may include first and second filtering units 260 and 262, the first and second passive signal directing units 220 and 240 may be duplexers, and the signal booster 200B may not include the second antenna 206.

The first filtering unit 260 may be communicatively coupled between the first common duplexer 211 and the first uplink gain unit 216. The first filtering unit 260 may be configured to provide further filtering along the uplink path in the first amplifying ring 210 and in the signal booster 200B. Further, filtering the uplink signal may allow for the signal booster 200B and/or the first amplifying ring 210 to apply a higher gain to an uplink signal and/or downlink signal.

The second filtering unit 262 may be communicatively coupled between the second passive signal directing unit duplexer 240 and the second downlink gain unit 238. The second filtering unit 262 may be configured to provide further filtering along the downlink path in the second amplifying ring 230 and in the signal booster 200B. Further filtering the downlink signal may allow for the signal booster 200B and/or the second amplifying ring 230 to apply a higher gain to an uplink signal and/or downlink signal.

As illustrated in FIG. 2B, the signal booster 200B may be connected to a modem 270 or some other component configured to demodulate and/or modulate a signal. In the illustrated embodiments, the modem 270 is communicatively coupled to the second interface port 208. In some embodiments, the modem 270 may be communicatively coupled to the second interface port 208 by cabling, such as a coaxial cable, among other types of cabling.

Modifications, additions, or omissions may be made to the signal booster 200B without departing from the scope of the present disclosure. For example, in some embodiments, the first and second filtering units 260 and 262 may be in different locations within the signal booster 200B. For example, the first filtering unit 260 may be communicatively coupled between the first passive signal directing unit 220 and the first uplink gain unit 216.

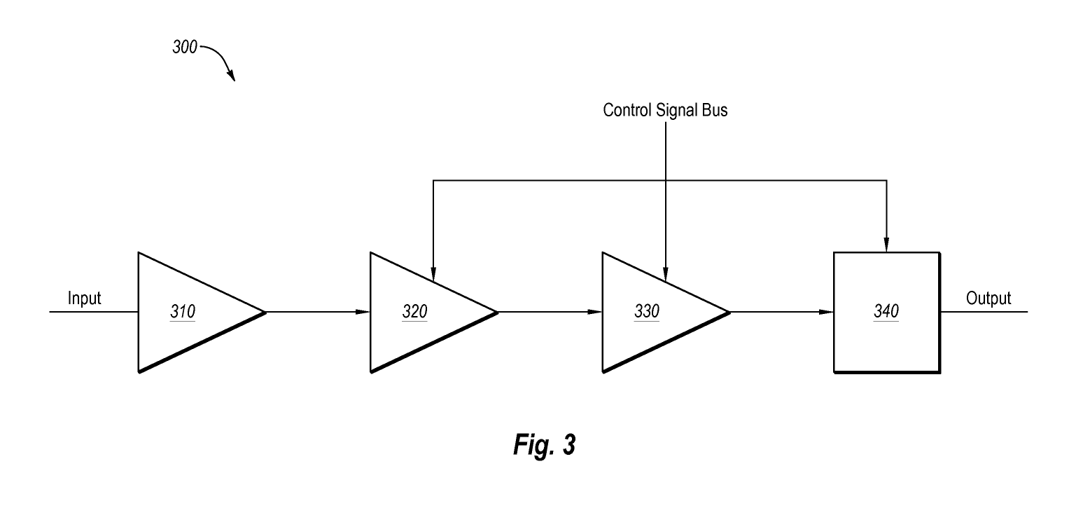

FIG. 3 is an embodiment of an example gain unit 300, arranged in accordance with at least some embodiments described herein. The gain unit 300 may be an example of any one or more of the gain units 216, 218, 236, and 238 of the signal booster 200A of FIG. 2A or FIG. 2B.

The gain unit 300 may include an amplifier 310, a first variable amplifier 320, a second variable amplifier 330, and a variable attenuator 340 between an input and an output. The amplifier 310 may have a set gain that the amplifier 310 may apply to a signal at the input of the gain unit 300. The amplifier 310 may apply the set gain to the signal and may pass the signal to the first variable amplifier 320.

The first variable amplifier 320 may have a variable gain that the first variable amplifier 320 may apply to the signal received from the amplifier 310. The variable gain of the first variable amplifier 320 may be determined based on a control signal on a control signal bus received by the first variable amplifier 320. The first variable amplifier 320 may apply a gain to the signal based on the control signal and may pass the signal to the second variable amplifier 330.

The second variable amplifier 330 may have a variable gain that the second variable amplifier 330 may apply to the signal received from the first variable amplifier 320. The variable gain of the second variable amplifier 330 may be determined based on a control signal on a control signal bus received by the second variable amplifier 330. The second variable amplifier 330 may apply a gain to the signal based on the control signal and may pass the signal to the variable attenuator 340.

The variable attenuator 340 may have a variable attenuation that the variable attenuator 340 may apply to the signal received from the second variable amplifier 330. The attenuation of the variable attenuator 340 may be determined based on a control signal on a control signal bus received by the variable attenuator 340. The variable attenuator 340 may apply an attenuation to the signal based on the control signal and pass the signal to the output of the gain unit 300.

Using the amplifier 310, the first and second variable amplifiers 320 and 330, and the variable attenuator 340, the gain unit 300 may be configured to apply a variety of gains to a signal received at the input of the gain unit 300. For example, for a low gain, the first and second variable amplifiers 320 and 330 may have a minimal gain and the variable attenuator 340 may have a high attenuation. As another example, for a high gain, the first and second variable amplifiers 320 and 330 may have high gains and the variable attenuator 340 may not apply an attenuation.

Modifications, additions, or omissions may be made to the gain unit 300 without departing from the scope of the present disclosure. For example, in some embodiments, the gain unit 300 may not include the one of the first or second variable attenuators 320 and 330. Alternately or additionally, in some embodiments, the gain unit 300 may not include the amplifier 310 or the variable attenuator 340. Alternately or additionally, the gain unit 300 may not include the variable attenuator 340. In some embodiments, the first and second variable amplifiers 320 and 330 may be controlled together by the same control signal or individually by different control signals.

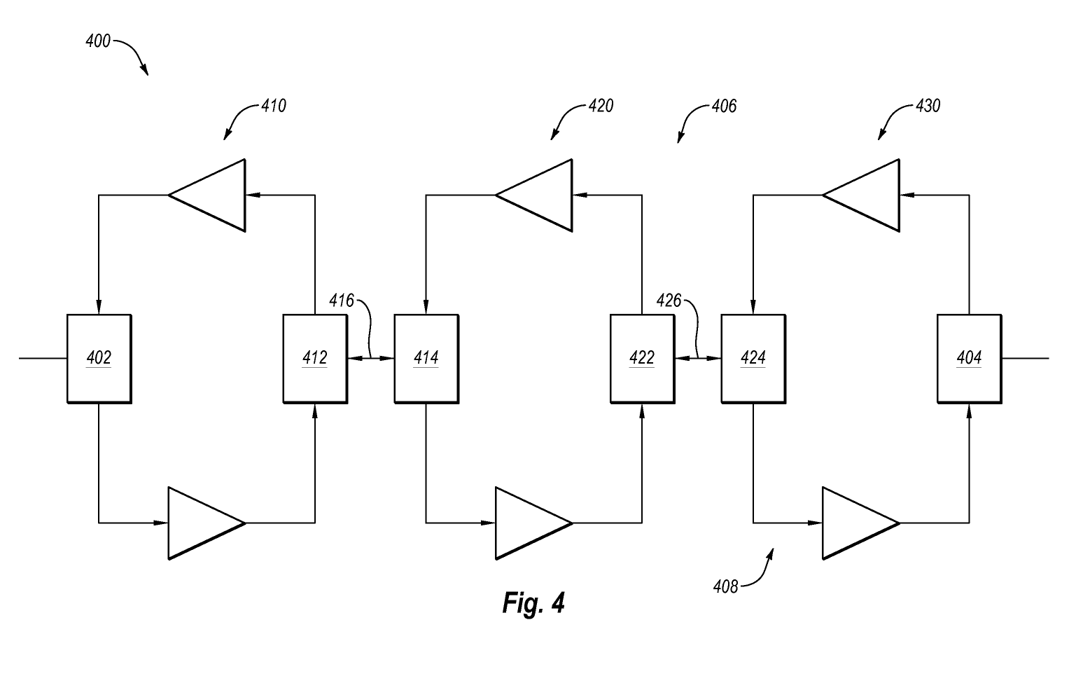

FIG. 4 is an embodiment of another example signal booster 400, arranged in accordance with at least some embodiments described herein. In some embodiments, the signal booster 400 may be implemented as the signal booster 102 of FIG. 1. In the illustrated embodiment, the signal booster 400 is configured to apply a gain to uplink signals communicated in an uplink band included in a communication band (e.g., the uplink band of the 3G Band 8) and to apply a gain to downlink signals in a downlink band included in the communication band (e.g., the downlink band of the 3G Band 8). In particular, the signal booster 400 may apply a gain to uplink signals traversing an uplink path 406 and a gain to a downlink signal traversing a downlink path 408.

The signal booster 400 may include first, second, and third amplifying rings 410, 420, and 430. The first amplifying ring 410 may include a first common duplexer 402 and a first passive signal directing unit 412 and one or gain units. The second amplifying ring 420 may include a second passive signal directing unit 414 and a third passive signal directing unit 422 and one or gain units. The third amplifying ring 430 may include a fourth passive signal directing unit 424 and a second common duplexer 404 and one or gain units.

The signal booster 400 may include first and second common paths 416 and 426 shared by both the uplink path 406 and the downlink path 408. The first common path 416 may communicatively couple the first and second amplifying rings 410 and 420. In particular, the first common path 416 may communicatively couple the first passive signal directing unit 412 and the second passive signal directing unit 414. The second common path 426 may communicatively couple the second and third amplifying rings 420 and 430. In particular, the second common path 426 may communicatively couple the third passive signal directing unit 422 and the fourth passive signal directing unit 424.

In some embodiments, each of the first, second, and third amplifying rings 410, 420, and 430 may provide sufficient filtering to prevent or reduce the occurrences of internal oscillation in the signal booster 400 and in each of the first, second, and third amplifying rings 410, 420, and 430.

Modifications, additions, or omissions may be made to the signal booster 400 without departing from the scope of the present disclosure. For example, in some embodiments, the signal booster 400 may include additional amplifying rings, such as fourth and fifth amplifying rings. Each of the additional amplifying rings may include two additional passive signal directing units and another common path shared by the uplink and downlink paths 406 and 408.

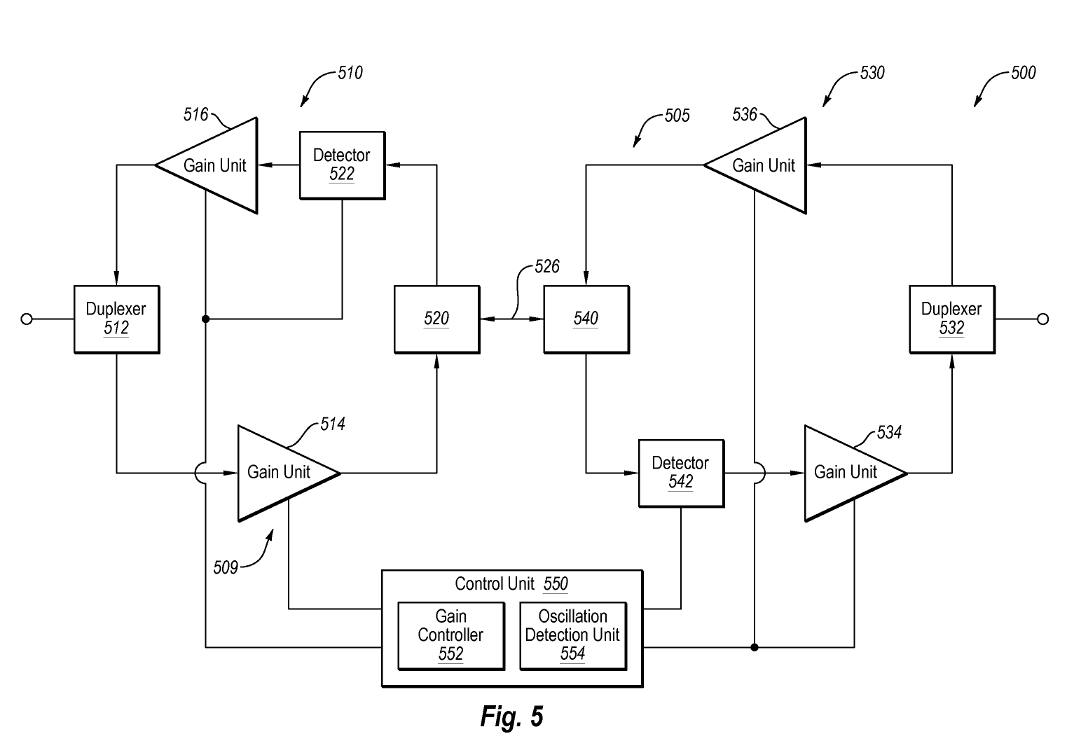

FIG. 5 is an example embodiment of another signal booster 500, arranged in accordance with at least some embodiments described herein. In some embodiments, the signal booster 500 may be implemented similar to the signal booster 102 of FIG. 1. In the illustrated embodiment, the signal booster 500 is configured to apply a gain to uplink signals communicated in an uplink band included in a communication band (e.g., the uplink band of the 3G Band 8) and to apply a gain to downlink signals in a downlink band included in the communication band (e.g., the downlink band of the 3G Band 8). In particular, the signal booster 500 may apply a gain to uplink signals traversing an uplink path 505 and a gain to a downlink signal traversing a downlink path 509. In some embodiments, the uplink signals may be referred to as first direction signals and the downlink signals as second direction signals or vice versa.

The signal booster 500 may include first and second amplifying rings 510 and 530. The first amplifying ring 510 may include a first common duplexer 512, a first downlink gain unit 514, a first uplink gain unit 516, a first passive signal directing unit 520, and a first detector 522. The second amplifying ring 530 may include a second common duplexer 532, a second downlink gain unit 534, a second uplink gain unit 536, a second passive signal directing unit 540, and a second detector 542.

The first amplifying ring 510 may be communicatively coupled to the second amplifying ring 530 by a common path 526. In particular, the common path 526 may communicatively couple the first passive signal directing unit 520 with the second passive signal directing unit 540. The common path 526 may be a path that both the uplink and downlink signals traverse within the signal booster 500. The first and second amplifying rings 510 and 530 may be analogous in operation to the first and second amplifying rings 210 and 230 of FIG. 2A. In particular, the first common duplexer 512, the first downlink gain unit 514, the first uplink gain unit 516, the first passive signal directing unit 520, the second common duplexer 532, the second downlink gain unit 534, the second uplink gain unit 536, and the second passive signal directing unit 540 may be analogous to the first common duplexer 211, the first downlink gain unit 218, the first uplink gain unit 216, the first passive signal directing unit 220, the second common duplexer 231, the second downlink gain unit 238, the second uplink gain unit 236, and the second passive signal directing unit 240, respectively, of FIG. 2A.

The signal booster 500, including the first and second amplifying rings 510 and 530, may result in internal oscillations occurring in one or both of the first and second amplifying rings 510 and 530 of the signal booster 500. As noted previously, internal oscillations may occur when a gain of gain units within an amplifying ring for a frequency is more than the filtering in the amplifying ring. In some embodiments, the signal booster 500 may be configured such that internal oscillations may seldom if ever occur (e.g., when the filtering of an amplifying ring is significantly greater than a gain in the amplifying ring).

Alternately or additionally, the signal booster 500 may be configured such that internal oscillations may occur under various circumstances (e.g., when the filtering of an amplifying ring is marginally greater than a gain in the amplifying ring). For example, when filtering of an amplifying ring is marginally greater than a gain in the amplifying ring under first conditions, under second conditions the filtering of the amplifying ring may be marginally less than a gain in the amplifying ring, resulting in internal oscillations. The second conditions may result from different voltage supply levels or operating temperatures of the signal booster 500. In these and other embodiments, the internal oscillations may lead to the signal booster 500 raising a noise floor or otherwise interfering with other devices operating in a network in which the signal booster 500 is operating. To reduce the interference generated by the signal booster 500 when the signal booster 500 is internally oscillating, the signal booster 500 may be configured to detect internal oscillations and to take one or more actions to reduce or eliminate internal oscillations once detected. Alternately or additionally, the signal booster 500 may be configured to detect when the signal booster 500 is about to internally oscillate and to reduce or eliminate the conditions resulting in internal oscillations to help prevent internal oscillations from occurring.

To help detect, reduce, and/or prevent oscillations, the signal booster 500 may include a control unit 550. The control unit 550 may include a gain controller 552 and an oscillation detection unit 554 and may be communicatively coupled to the first and second detectors 522 and 542 and to the first and second uplink and downlink gain units 514, 516, 534, and 536. The control unit 550 may be configured to detect internal oscillations within the first and second amplifying rings 510 and 530 or when the first and second amplifying rings 510 and 530 are close to internally oscillating and to adjust gains applied to uplink and/or downlink signals in the first and/or second amplifying rings 510 and 530 to reduce, eliminate, and/or prevent internal oscillations detected in the first and/or second amplifying rings 510 and 530.

In general, the oscillation detection unit 554 may be configured to detect internal oscillations or when signal booster 500 is close to internally oscillating based on data received from the first and/or second detectors 522 and 542. The gain controller 552 may be configured to adjust gains applied to uplink and downlink signals using one or more of the first and second uplink and downlink gain units 514, 516, 534, and 536 to detect internal oscillations or the signal booster 500 being close to internally oscillating. The gain controller 552 may be further configured to adjust gains applied to uplink and downlink signals using one or more of the first and second uplink and downlink gain units 514, 516, 534, and 536 to reduce, eliminate, and/or prevent internal oscillations detected in the first and/or second amplifying rings 510 and 530.

To detect oscillations in the first and second amplifying rings 510 and 530, either or both of the first and second detectors 522 and 542 may be used. Detecting internal oscillations using either or both of the first and second detectors 522 and 542 is explained separately.

To detect oscillations in the first amplifying ring 510 using the first detector 522, the first detector 522 first determines an amplitude of an uplink signal along the uplink path 505. The first detector 522 sends the amplitude of the uplink signal to the oscillation detection unit 554. The gain controller 552 may then adjust the gain of the first downlink gain unit 514. In some embodiments, the gain controller 552 may increase or decrease the gain of the first downlink gain unit 514. In some embodiments, the gain controller 552 may decrease the gain of the first downlink gain unit 514 to avoid amplifying a downlink signal beyond an amplitude level appropriate for the downlink signal. After the gain of the first downlink gain unit 514 is adjusted, the first detector 522 determines an amplitude of an uplink signal along the uplink path 505 and sends the amplitude to the oscillation detection unit 554.

The oscillation detection unit 554 is configured to compare the amplitude of the uplink signal obtained before the gain of the first downlink gain unit 514 is adjusted with the amplitude of the uplink signal after the gain of the first downlink gain unit 514 is adjusted. The amplitude of the uplink signal changing in a similar manner with the change of the gain of the first downlink gain unit 514, and thus a change in the gain of the downlink signal, may indicate that an internal oscillation is occurring in the first amplifying ring 510 or that the first amplifying ring 510 is close to internally oscillating.

The amplitude of a first direction signal (e.g., the uplink signal) changing in a similar manner with the change of the gain applied to a second direction signal (e.g., the downlink signal) indicates internal oscillation because under normal conditions, e.g., non-oscillating conditions or not close to oscillating conditions, changing the gain applied to a second direction signal does not affect an amplitude of a first direction signal. The gain applied to a second direction signal not affecting an amplitude of a first direction signal occurs under normal conditions because filtering in the signal booster 500 is sufficient to prevent a signal at a frequency from being above a noise floor when amplified by a gain unit in either the uplink or downlink paths 505 and 509. During an internal oscillation or when an internal oscillation is close to occurring, the filtering in the signal booster 500 is insufficient to prevent a signal at a frequency from being above a noise floor when amplified by a gain unit in the uplink or downlink paths 505 and 509.

For example, for a mid-band frequency of a guard band, when the signal booster 500 and, in particular, the first amplifying ring 510 is not oscillating, a gain may be applied by the first downlink gain unit 514 and the first uplink gain unit 516 to the mid-band frequency. However, the first common duplexer 512 and the first passive signal directing unit 520 may filter/isolate the mid-band frequency so that the amplitude of the mid-band frequency at the first detector 522 is at the noise floor.

In contrast, when the first amplifying ring 510 is oscillating or close to oscillating, the first common duplexer 512 and/or the first passive signal directing unit 520 may not filter/isolate the mid-band frequency as much as the gain applied by the first downlink gain unit 514 and the first uplink gain unit 516. As a result, the mid-band frequency may have an amplitude above the noise floor detected by the first detector 522. When the gain of the first downlink gain unit 514 is increased, the amplitude of the mid-band frequency within the uplink path 505, and consequently the amplitude of the uplink signal, is increased and when the gain of the first downlink gain unit 514 is decreased, the amplitude of the mid-band frequency within the uplink path 505, and consequently the amplitude of the uplink signal, is decreased. The resulting change in the amplitude of the uplink signal, e.g., the increase or decrease of the uplink signal, is detected by the oscillation detection unit 554 based on the amplitudes of the uplink signal provided by the first detector 522.

Oscillations may also be detected in the first amplifying ring 510 using the first detector 522 by adjusting a gain of the second uplink gain unit 536. The first detector 522 first determines an amplitude of an uplink signal along the uplink path 505. The first detector 522 sends the amplitude of the uplink signal to the oscillation detection unit 554. The gain controller 552 may then adjust the gain of the second uplink gain unit 536. In some embodiments, the gain controller 552 may increase or decrease the gain of the second uplink gain unit 536. After the gain of the second uplink gain unit 536 is adjusted, the first detector 522 determines an amplitude of an uplink signal along the uplink path 505 and sends the amplitude to the oscillation detection unit 554.

The oscillation detection unit 554 is configured to compare the amplitude of the uplink signal obtained before the gain of the second uplink gain unit 536 is adjusted with the amplitude of the uplink signal after the gain of the second uplink gain unit 536 is adjusted. The amplitude of the uplink signal not changing in a similar manner with the change of the gain of the second uplink gain unit 536 may indicate that an internal oscillation is occurring in the first amplifying ring 510 or that the first amplifying ring 510 is close to internal oscillation. Thus, the amplitude of the uplink signal maintaining approximately constant or varying significantly less than the change in gain of the second uplink gain unit 536 indicates that an internal oscillation is occurring in the first amplifying ring 510 or that the first amplifying ring 510 is close to internally oscillating.

Note that when an amplitude is determined for a first direction signal (e.g., an uplink signal) and a gain of a second direction signal (e.g., a downlink signal) is changed, the amplitude of the first direction signal changing in a similar manner with the change of the gain of the second direction signal indicates internal oscillation in an amplifying ring or the amplifying ring being close to internally oscillating. In contrast, when an amplitude is determined for a first direction signal (e.g., an uplink signal) and a gain of the first direction signal (e.g., a downlink signal) is changed, the amplitude of the first direction signal changing in a similar manner with the change of the gain of the first direction signal does not indicate internal oscillation in an amplifying ring or the amplifying ring being close to internally oscillating.

To detect internal oscillations in the second amplifying ring 530 using the first detector 522, the first detector 522 first determines an amplitude of an uplink signal along the uplink path 505. The first detector 522 sends the amplitude of the uplink signal to the oscillation detection unit 554. The gain controller 552 may then adjust the gain of the second downlink gain unit 534. In some embodiments, the gain controller 552 may increase or decrease the gain of the second downlink gain unit 534. After the gain of the second downlink gain unit 534 is adjusted, the first detector 522 determines an amplitude of an uplink signal along the uplink path 505 and sends the amplitude to the oscillation detection unit 554.

The oscillation detection unit 554 is configured to compare the amplitude of the uplink signal obtained before the gain of the second downlink gain unit 534 is adjusted with the amplitude of the uplink signal after the gain of the second downlink gain unit 534 is adjusted. The amplitude of the uplink signal changing in a similar manner with the change of the gain of the second downlink gain unit 534, and thus a change in the gain of the downlink signal, may indicate that an internal oscillation is occurring in the second amplifying ring 530 or that the second amplifying ring 530 is close to internally oscillating.

To detect internal oscillations in the second amplifying ring 530 using the second detector 542, the second detector 542 first determines an amplitude of a downlink signal along the downlink path 509. The second detector 542 sends the amplitude of the downlink signal to the oscillation detection unit 554. The gain controller 552 may then adjust the gain of the second uplink gain unit 536. In some embodiments, the gain controller 552 may increase or decrease the gain of the second uplink gain unit 536. After the gain of the second uplink gain unit 536 is adjusted, the second detector 542 determines an amplitude of a downlink signal along the downlink path 509 and sends the amplitude to the oscillation detection unit 554.

The oscillation detection unit 554 is configured to compare the amplitude of the downlink signal obtained before the gain of the second uplink gain unit 536 is adjusted with the amplitude of the downlink signal after the gain of the second uplink gain unit 536 is adjusted. The amplitude of the downlink signal changing in a similar manner with the change of the gain of the second uplink gain unit 536, and thus a change in the gain of the downlink signal, may indicate that an internal oscillation is occurring in the second amplifying ring 530 or that second amplifying ring 530 is close to internally oscillating.

To detect internal oscillations in the second amplifying ring 530 or that the second amplifying ring 530 is close to internally oscillating using the second detector 542, an amplitude of a downlink signal may be determined before and after adjusting a gain of the first downlink gain unit 514 and comparing the amplitudes as discussed above.

To detect internal oscillations in the first amplifying ring 510 or that the first amplifying ring 510 is close to internally oscillating using the second detector 542, an amplitude of a downlink signal may be determined before and after adjusting a gain of the first uplink gain unit 516 or the first downlink gain unit 514 and comparing the amplitudes as discussed above.

After an internal oscillation is detected in an amplifying ring or that the amplifying ring is close to internally oscillating, a gain in either or both of the uplink or downlink gains units may be reduced. For example, when an internal oscillation is detected in the first amplifying ring 510, the gain of the first downlink gain unit 514 and/or the gain of the first uplink gain unit 516 may be reduced.

In some embodiments, performing operations as discussed herein to detect internal oscillations in an amplifying ring or to detect that the amplifying ring is close to internally oscillating may occur periodically at even or random intervals. In some embodiments, performing operations to detect internal oscillations in an amplifying ring or to detect that the amplifying ring is close to internally oscillating may occur for each amplifying ring in a signal booster sequentially or non-sequentially. Alternately or additionally, performing operations to detect internal oscillations in an amplifying ring or to detect that the amplifying ring is close to internally oscillating may occur more often for some amplifying rings in a signal booster than other amplifying rings in the signal booster.

In some embodiments, the control unit 550 and thus the gain controller 552 and the oscillation detection unit 554 may be implemented by any suitable mechanism, such as a program, software, function, library, software as a service, analog or digital circuitry, or any combination thereof. The control unit 550 may also include a processor coupled to memory. The processor may include, for example, a microprocessor, microcontroller, digital signal processor (DSP), application specific integrated circuit (ASIC), a Field Programmable Gate Array (FPGA), or any other digital or analog circuitry configured to interpret and/or to execute program instructions and/or to process data. In some embodiments, the processor may interpret and/or execute program instructions and/or process data stored in the memory. The instructions may include instructions for adjusting the gains of the gain units 514, 516, 534, and 536 and/or detecting internal oscillations.

The memory may include any suitable computer-readable media configured to retain program instructions and/or data for a period of time. By way of example, and not limitation, such computer-readable media may include tangible computer-readable storage media including Random Access Memory (RAM), Read-Only Memory (ROM), Electrically Erasable Programmable Read-Only Memory (EEPROM), Compact Disc Read-Only Memory (CD ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media. Computer-executable instructions may include, for example, instructions and data that cause a general purpose computer, special purpose computer, or special purpose processing device to perform a certain function or group of functions.

Modifications, additions, or omissions may be made to the signal booster 500 without departing from the scope of the present disclosure. For example, the signal booster 500 may include one but not both of the first and second detectors 522 and 542. In these and other embodiments, the control unit 550 may be coupled to some but not all of the gain units 514, 516, 534, and 536 in the signal booster 500. For example, when the signal booster 500 includes the first detector 522 and not the second detector 542, the control unit 550 may be coupled to and control the gain applied by the first and second downlink gain units 514 and 534. Alternately or additionally, the control unit 550 may be coupled to and control the gain applied by the second downlink gain unit 534 and the second uplink gain unit 536.

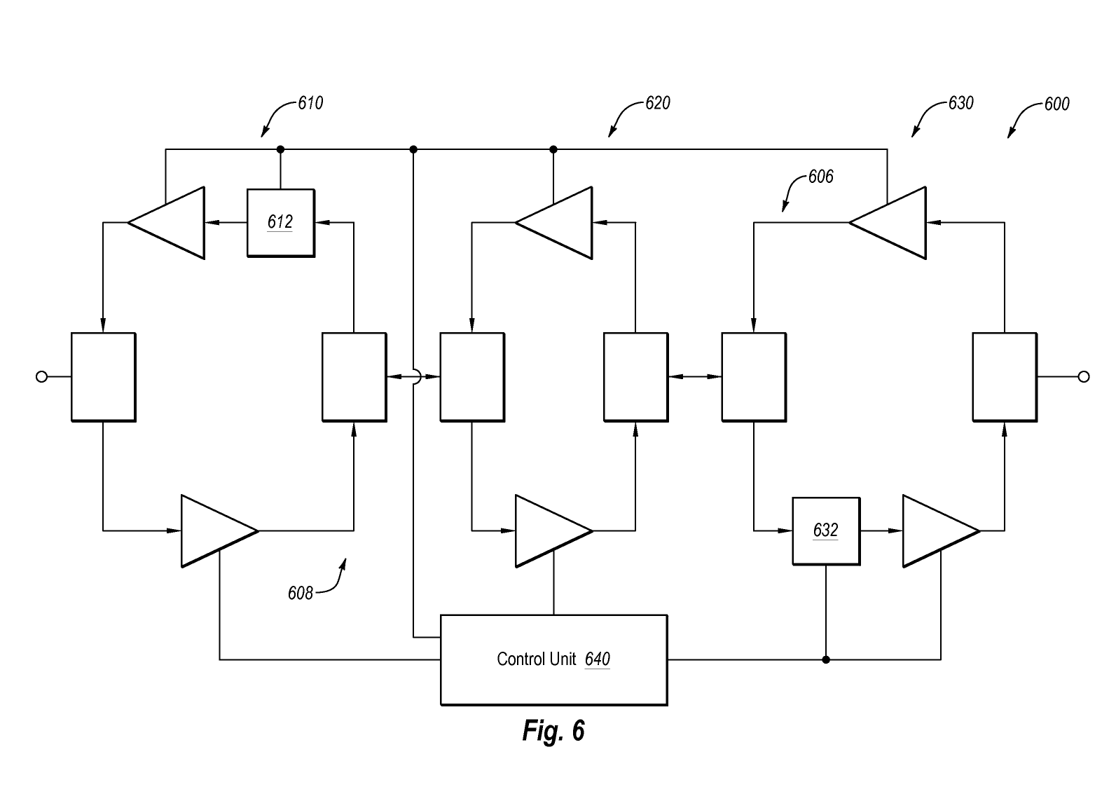

FIG. 6 is an example embodiment of another signal booster 600, arranged in accordance with at least some embodiments described herein. In some embodiments, the signal booster 600 may be implemented as the signal booster 102 of FIG. 1. In the illustrated embodiment, the signal booster 600 is configured to apply a gain to uplink signals communicated in an uplink band included in a communication band (e.g., the uplink band of the 3G Band 8) and to apply a gain to downlink signals in a downlink band included in the communication band (e.g., the downlink band of the 3G Band 8). In particular, the signal booster 600 may apply a gain to uplink signals traversing an uplink path 606 and a gain to a downlink signal traversing a downlink path 608.

The signal booster 600 may include first, second, and third amplifying rings 610, 620, and 630. The first, second, and third amplifying rings 610, 620, and 630 may be analogous to the first, second, and third amplifying rings 410, 420, and 430 of FIG. 4.

Each of the first, second, and third amplifying rings 610, 620, and 630 may include uplink gain units in the uplink path 606 and downlink gain units in the downlink path 608 that may be coupled to a control unit 640. The gains of the uplink and downlink gain units applied to uplink and downlink signals, respectively, are controlled by the control unit 640.

The first amplifying ring 610 may include a first detector 612 and the third amplifying ring 630 may include a second detector 632. The first and second detectors 612 and 632 may be configured to determine an amplitude of an uplink signal and a downlink signal, respectively. The first and second detectors 612 and 632 may be coupled to the control unit 640 and be configured to send the determined amplitudes of the uplink and downlink signals, respectively, to the control unit 640.

The control unit 640 may be analogous to the control unit 550 of FIG. 5 and may be configured to determine when one or more of the first, second, and third amplifying rings 610, 620, and 630 are internally oscillating or are close to internally oscillating and to reduce or eliminate internal oscillations of the first, second, and third amplifying rings 610, 620, and 630. The control unit 640 may determine when one or more of the first, second, and third amplifying rings 610, 620, and 630 are internally oscillating or are close to internally oscillating using amplitudes of uplink signals from the first detector 612 or amplitudes of downlink signals from the second detector 632.

Using the first detector 612, the control unit 640 may determine when the third amplifying ring 630 is internally oscillating or close to internally oscillating using amplitudes of the uplink signal provided by the first detector 612 and by adjusting a downlink gain unit in the third amplifying ring 630.

Using the first detector 612, the control unit 640 may also determine when the second amplifying ring 620 is internally oscillating or close to internally oscillating using amplitudes of the uplink signal provided by the first detector 612 and by adjusting a downlink gain unit in the second amplifying ring 620 or an uplink gain unit in the third amplifying ring 630.

Using the first detector 612, the control unit 640 may also determine when the first amplifying ring 610 is internally oscillating or close to internally oscillating based on amplitudes of the uplink signal provided by the first detector 612 and by adjusting a downlink gain unit in the first amplifying ring 610 or an uplink gain unit in the third amplifying ring 630 or an uplink gain unit in the second amplifying ring 620.

Using the second detector 632, the control unit 640 may determine when the third amplifying ring 630 is internally oscillating or close to internally oscillating using amplitudes of the downlink signal provided by the second detector 632 and by adjusting an uplink gain unit in the third amplifying ring 630.

Using the second detector 632, the control unit 640 may also determine when the second amplifying ring 620 is internally oscillating or close to internally oscillating using amplitudes of the downlink signal provided by the second detector 632 and by adjusting a downlink gain unit in the second amplifying ring 620 or an uplink gain unit in the first amplifying ring 610.

Using the second detector 632, the control unit 640 may also determine when the first amplifying ring 610 is internally oscillating or close to internally oscillating using amplitudes of the downlink signal provided by the second detector 632 and by an uplink gain unit in the first amplifying ring 610.

Note that a single detector in the uplink path 606 or the downlink path 608 may provide sufficient information for the control unit 640 to determine when one or more of the first, second, and third amplifying rings 610, 620, and 630 are internally oscillating or are close to internally oscillating. Thus, multiple amplifying rings within a signal booster, such as the first and second amplifying rings 610 and 620 may not include a detector. However, internal oscillations within each of the amplifying rings may still be detected.

Modifications, additions, or omissions may be made to the signal booster 600 without departing from the scope of the present disclosure. For example, the signal booster 600 may include the first detector 612 or the second detector 632 but not both. In some embodiments, the signal booster 600 may include an additional detector in the second amplifying ring 620. Alternately or additionally, the signal booster 600 may include additional amplifying rings.

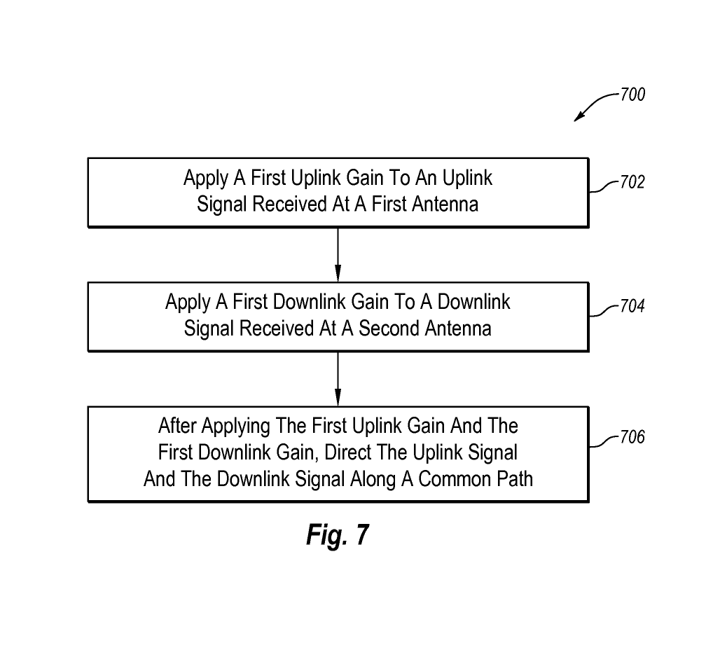

FIG. 7 is a flowchart of an example method 700 of amplifying a signal, arranged in accordance with at least some embodiments described herein. The method 700 may be implemented, in some embodiments, by a signal booster, such as the signal booster 200A, 200B, 400, 500, or 600 of FIGS. 2A, 2B, 4, 5, and 6, respectively. Although illustrated as discrete blocks, various blocks may be divided into additional blocks, combined into fewer blocks, or eliminated, depending on the desired implementation.

The method 700 may begin at block 702, a first uplink gain may be applied to an uplink signal received at a first antenna. In block 704, a first downlink gain may be applied to a downlink signal received at a second antenna. In block 706, after the first uplink gain and the first downlink gain are applied, the uplink signal and the downlink signal may be directed along a common path.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For instance, the method 700 may further include applying a second uplink gain to the uplink signal and applying a second downlink gain to the downlink signal. In these and other embodiments, the uplink signal and the downlink signal may be directed along the common path occurring before applying the second uplink gain and the second downlink gain.

Alternately or additionally, the method 700 may include filtering/isolating the uplink signal and the downlink signal after applying the first uplink gain and the first downlink gain and before directing the uplink signal and the downlink signal along the common path.

Alternately or additionally, the method 700 may include separating the uplink signal and the downlink signal after directing the uplink signal and the downlink signal along the common path.

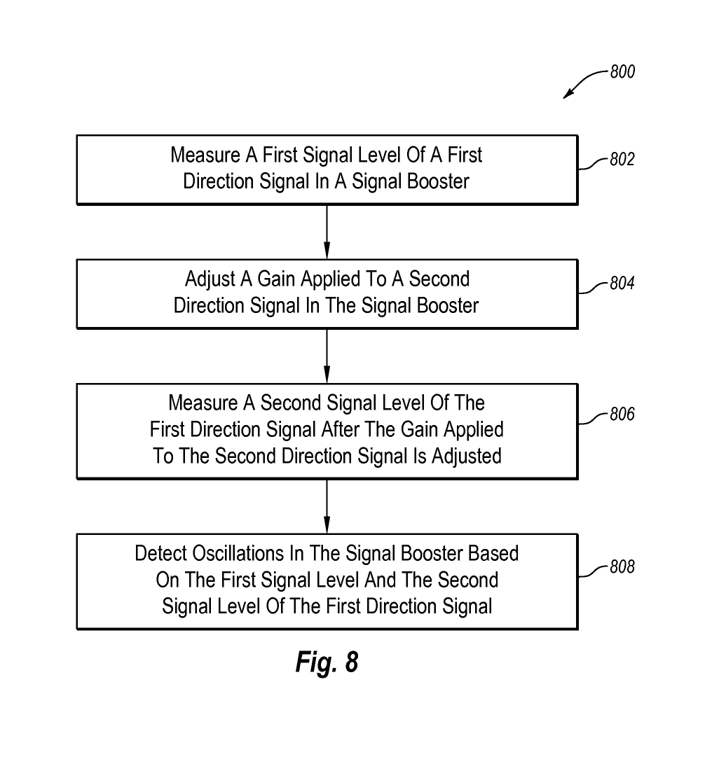

FIG. 8 is a flowchart of an example method 800 of detecting internal oscillations in a signal booster, arranged in accordance with at least some embodiments described herein. The method 800 may be implemented, in some embodiments, by a signal booster, such as the signal boosters 500 or 600 of FIGS. 5 and 6, respectively. Although illustrated as discrete blocks, various blocks may be divided into additional blocks, combined into fewer blocks, or eliminated, depending on the desired implementation.

The method 800 may begin at block 802, where a first signal level of a first direction signal in a signal booster may be measured. In block 804, a gain applied to a second direction signal in the signal booster may be adjusted. In some embodiments, the first direction signal may be an uplink signal and the second direction signal may be a downlink signal. In some embodiments, the first direction signal may be a downlink signal and the second direction signal may be an uplink signal.

In block 806, a second signal level of the first direction signal after the gain applied to the second direction signal is adjusted may be measured. In block 808, oscillations in the signal booster may be detected based on the first signal level and the second signal level of the first direction signal.

In some embodiments, the measuring the first signal level of the first direction signal may occur in a first amplifying ring of the signal booster and the adjusting the gain applied to the second direction signal may occur in a second amplifying ring of the signal booster. In these and other embodiments, the oscillations may be detected in the second amplifying ring. Alternately or additionally, the measuring the first signal level of the first direction signal may occur in a first amplifying ring of the signal booster and the adjusting the gain applied to the second direction signal may occur in the first amplifying ring. In these and other embodiments, the oscillations may be detected in the first amplifying ring.

In some embodiments, the method 800 may include additional steps or operations. For example, the method 800 may further include adjusting a gain applied to the second direction signal in a third amplifying ring of the signal booster and measuring a third signal level of the first direction signal in the first amplifying ring after the gain applied to the second direction signal in the third amplifying ring is adjusted. The method 800 may further include detecting oscillations in the signal booster based on the third signal level of the first direction signal.

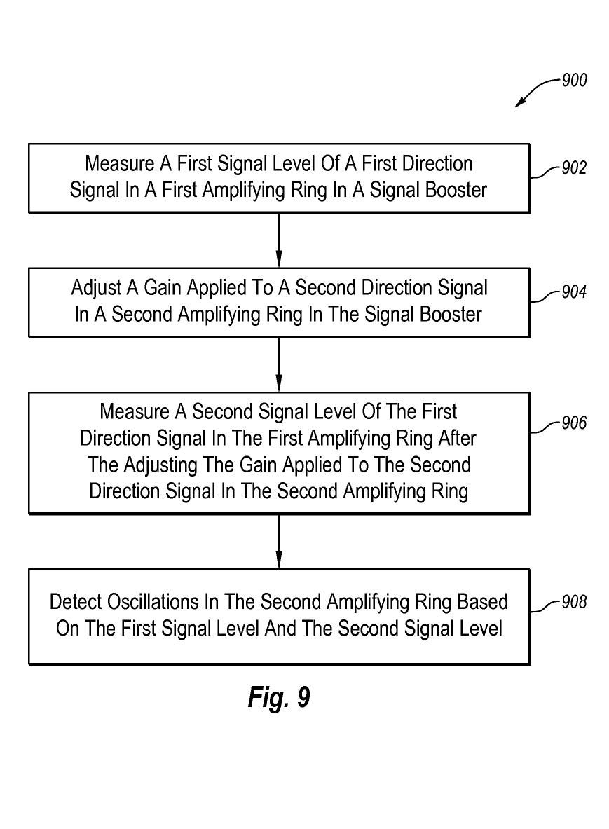

FIG. 9 is a flowchart of another example method 900 of detecting internal oscillations in a signal booster, arranged in accordance with at least some embodiments described herein. The method 900 may be implemented, in some embodiments, by a signal booster, such as the signal boosters 500 or 600 of FIGS. 5 and 6, respectively. Although illustrated as discrete blocks, various blocks may be divided into additional blocks, combined into fewer blocks, or eliminated, depending on the desired implementation.

The method 900 may begin at block 902, where a first signal level of a first direction signal in a first amplifying ring in a signal booster may be measured. In block 904, a gain applied to a second direction signal in a second amplifying ring in the signal booster may be adjusted. In some embodiments, the first direction signal may be an uplink signal and the second direction signal may be a downlink signal. Alternately or additionally, the first direction signal may be a downlink signal and the second direction signal may be an uplink signal.

In block 906, a second signal level of the first direction signal in the first amplifying ring may be measured after the gain applied to the second direction signal in the second amplifying ring is adjusted. In block 908, oscillations in the second amplifying ring may be detected based on the first signal level and the second signal level.

In some embodiments, the method 900 may include additional step or operations. For instance, the method 900 may further include adjusting a gain applied to the first direction signal in a third amplifying ring in the signal booster and measuring a third signal level of the first direction signal in the first amplifying ring after the adjusting the gain applied to the first direction signal in the third amplifying ring. The method 900 may further include detecting oscillations in the third amplifying ring based on the third signal level.

In some embodiments, the method 900 may further include adjusting a gain applied to the second direction signal in the first amplifying ring and measuring a third signal level of the first direction signal in the first amplifying ring after adjusting the gain applied to the second direction signal in the first amplifying ring. The method 900 may further include detecting oscillations in the first amplifying ring based on the third signal level.

In some embodiments, the method 900 may further include measuring a third signal level of the second direction signal in the second amplifying ring and adjusting a gain applied to the first direction signal in the first amplifying ring. The method 900 may further include measuring a fourth signal level of the second direction signal in the second amplifying ring after the adjusting the gain applied to the first direction signal in the first amplifying ring and detecting oscillations in the first amplifying ring based on the third signal level and the fourth signal level.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present invention have been described in detail, it should be understood that the various changes, substitutions, and alterations could be made hereto without departing from the spirit and scope of the invention.

What is claimed is:

1. A signal booster comprising:
first and second uplink gain units each configured to apply an uplink gain to an uplink signal;
first and second downlink gain units each configured to apply a downlink gain to a downlink signal; and
a passive signal directing unit configured to communicatively couple the first uplink gain unit to the second uplink gain unit and to communicatively couple the first downlink gain unit to the second downlink gain unit.

2. The signal booster of claim 1, wherein the passive signal directing unit is a first passive signal directing unit, the signal booster further comprising a second passive signal directing unit configured to communicatively couple a first interface port to the first uplink gain unit and to the first downlink gain unit.

3. The signal booster of claim 2, further comprising a third passive signal directing unit configured to communicatively couple a second interface port to the second uplink gain unit and to the second downlink gain unit.

4. The signal booster of claim 1, wherein the passive signal directing unit is a first passive signal directing unit, the signal booster further comprising a second passive signal directing unit communicatively coupled to the passive signal directing unit, the second passive signal directing unit and the passive signal directing unit configured to communicatively couple the first uplink gain unit to the second uplink gain unit and to communicatively couple the first downlink gain unit to the second downlink gain unit.

5. The signal booster of claim 4, wherein the passive signal directing unit further includes a downlink port and an uplink port, wherein the downlink port is communicatively coupled to the first downlink gain unit and the uplink port is communicatively coupled to the first uplink gain unit.

6. The signal booster of claim 4, wherein the passive signal directing unit further includes a downlink port and an uplink port, wherein the downlink port is communicatively coupled to the second downlink gain unit and the uplink port is communicatively coupled to the second uplink gain unit.

7. The signal booster of claim 4, wherein the passive signal directing unit includes a common port and the second passive signal directing unit includes a common port, wherein the common port of the passive signal directing unit is communicatively coupled to the common port of the second passive signal directing unit.

8. The signal booster of claim 1, wherein passive signal directing unit is a duplexer, a splitter, a circulator, a triplexer, or a quadplexer.

9. A signal booster comprising:
a first amplifying ring that includes a first uplink gain unit communicatively coupled between first and second duplexers and a first downlink gain unit communicatively coupled between the first and second duplexers;
a second amplifying ring that includes a second uplink gain unit communicatively coupled between third and fourth duplexers and a second downlink gain unit communicatively coupled between the third and fourth duplexers; and
the second and third duplexers communicatively coupled such that the communicatively coupled second and third duplexers are configured to communicatively couple the first uplink gain unit to the second uplink gain unit and to communicatively couple the first downlink gain unit to the second downlink gain unit.

10. The signal booster of claim 9, wherein the second duplexer includes a common port and the third duplexer includes a common port, wherein the common port of the second duplexer is communicatively coupled to the common port of the third duplexer.

11. The signal booster of claim 9, wherein the fourth duplexer is communicatively coupled to a first interface port.

12. The signal booster of claim 11, wherein the first duplexer is communicatively coupled to a second interface port.

13. The signal booster of claim 9, wherein the first uplink gain unit, the first downlink gain unit, the second uplink gain unit, and the second downlink gain unit each includes one or more amplifiers.

14. The signal booster of claim 9, wherein the first uplink gain unit and the second uplink gain unit are each configured to apply an uplink gain to an uplink signal and the first downlink gain unit and the second downlink gain unit are each configured to apply a downlink gain to a downlink signal, wherein the uplink signal and the downlink signal are transmitted between an access point and a wireless device.

15. The signal booster of claim 9, further comprising a third amplifying ring that includes a third uplink gain unit communicatively coupled between fifth and sixth duplexers and a third downlink gain unit communicatively coupled between the fifth and sixth duplexers,
the fourth and fifth duplexers communicatively coupled such that the communicatively coupled fourth and fifth duplexers are configured to communicatively couple the third uplink gain unit to the second uplink gain unit and to communicatively couple the third uplink gain unit to the second downlink gain unit.

16. A method of amplifying a signal, the method comprising:
applying a first uplink gain to an uplink signal received at a first antenna;
applying a first downlink gain to a downlink signal received at a second antenna; and
after applying the first uplink gain and the first downlink gain, directing the uplink signal and the downlink signal along a common path.

17. The method of claim 16, further comprising:
applying a second uplink gain to the uplink signal; and
applying a second downlink gain to the downlink signal.

18. The method of claim 17, wherein the directing the uplink signal and the downlink signal along the common path occurs before applying the second uplink gain and the second downlink gain.

19. The method of claim 16, further comprising after applying the first uplink gain and the first downlink gain and before directing the uplink signal and the downlink signal along the common path, filtering the uplink signal and the downlink signal.

20. The method of claim 16, further comprising after directing the uplink signal and the downlink signal along the common path, separating the uplink signal and the downlink signal.
